(19) United States
(12) Patent Application Publication
(10) Pub. No.: US 2026/0189321 A1
(43) Pub. Date: Jul. 2, 2026

(54) RATE ADAPTATION METHOD AND APPARATUS THEREOF

(71) Applicant: MEDIATEK INC., Hsinchu City (TW)

(72) Inventors: Jia-Xin CHEN, Hsinchu City (TW); Yuan-Chin WEN, Hsinchu City (TW); Han-Cheng SHIH, Hsinchu City (TW)

(21) Appl. No.: 19/364,038

(22) Filed: Oct. 21, 2025

Related U.S. Application Data
(60) Provisional application No. 63/740,414, filed on Dec. 31, 2024.

(51) Int. Cl. H04L 1/00; H04B 17/309; H04B 17/318; H04L 41/16

(52) U.S. Cl. CPC H04L 1/0015; H04B 17/328; H04B 17/346; H04L 41/16

(57) ABSTRACT

A rate adaptation method is provided. The rate adaptation method may be applied to an apparatus. The rate adaptation method may include the following steps. A processor of the apparatus may detect a channel utilization (CU) information and a physical (PHY) code information. Then, the processor may perform a rate adaptation according to the CU information and the PHY code information through a neural network model.

### CROSS REFERENCE TO RELATED APPLICATIONS

This application claims the benefit of U.S. Provisional Application No. 63/740,414 filed on Dec. 31, 2024, the entirety of which is incorporated by reference herein.

### BACKGROUND OF THE INVENTION

### Field of the Invention

The invention generally relates to wireless communications technology, and more particularly, it relates to perform the rate adaptation based on the neural network model.

### Description of the Related Art

Unless otherwise indicated herein, approaches described in this section are not prior art to the claims listed below and are not admitted as prior art by inclusion in this section.

In the conventional technologies, the apparatus may periodically perform the rate adaptation to find suitable rate. However, in the conventional rate adaptation, the apparatus may need to hierarchically try different MCSs to find the appropriate target rate. Therefore, the latency for the rate adaptation is increased.

Therefore, how to perform a rate adaptation more precisely and fast is a topic that is worthy of discussion.

### BRIEF SUMMARY OF THE INVENTION

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods and apparatus pertaining to rate adaptation with respect to the apparatus. It is believed that the issue described above can be avoided or otherwise alleviated by implementing one or more of the proposed schemes described herein.

An embodiment of the invention provides a rate adaptation method. The rate adaptation method may be applied to an apparatus. The rate adaptation method may comprise the following steps. The processor of the apparatus may detect channel utilization (CU) information and physical (PHY) code information. Then, the processor may perform a rate adaptation according to the CU information and the PHY code information through a neural network model.

In some embodiments, the CU information may comprise at least one of a received signal strength indicator (RSSI), a signal-to-noise ratio (SNR), a noise variance, and a link quality.

In some embodiments, the PHY code may comprise at least one of a target modulation and coding scheme (MCS) index, a target number of space-time streams, a target medium access control (MAC) protocol data unit (MPDU) count, a target transmission (TX) power, a target power density, a condition number corresponding to a target TX bandwidth (BW), and a target modulation type.

In some embodiments, the neural network model comprises a fully connected neural network.

In some embodiments, during the rate adaptation, the rate adaptation method may comprise that the processor may perform a packet error rate (PER) prediction according to the CU information and the PHY code information through the neural network model to generate a prediction result, and select a target rate from a rate table according to a prediction result.

An embodiment of the invention provides an apparatus. The apparatus may comprise a transceiver and a processor. During operation, the transceiver may wirelessly communicate with a network node. The processor may be coupled to the transceiver such that, during operation, the processor performs the following operations. The processor may detect channel utilization (CU) information and physical (PHY) code information, and perform a rate adaptation according to the CU information and the PHY code information through a neural network model.

Other aspects and features of the invention will become apparent to those with ordinary skill in the art upon review of the following descriptions of specific embodiments of the rate adaptation method and apparatus.

### BRIEF DESCRIPTION OF THE DRAWINGS

The invention will become more fully understood by referring to the following detailed description with reference to the accompanying drawings, wherein:

FIG. 1 is a block diagram of a wireless communication system 100 according to an embodiment of the application.

FIG. 2 is a block diagram illustrating a communication apparatus according to an embodiment of the application.

FIG. 3 is a block diagram illustrating a network node according to an embodiment of the application.

FIG. 4 is a schematic diagram illustrating a neural network model training process according to an embodiment of the invention.

FIG. 5 is a schematic diagram illustrating a neural network model according to an embodiment of the invention.

FIG. 6 is a schematic diagram illustrating a MCS rate adaptation according to an embodiment of the invention.

FIG. 7 is a flow chart illustrating a rate adaptation method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

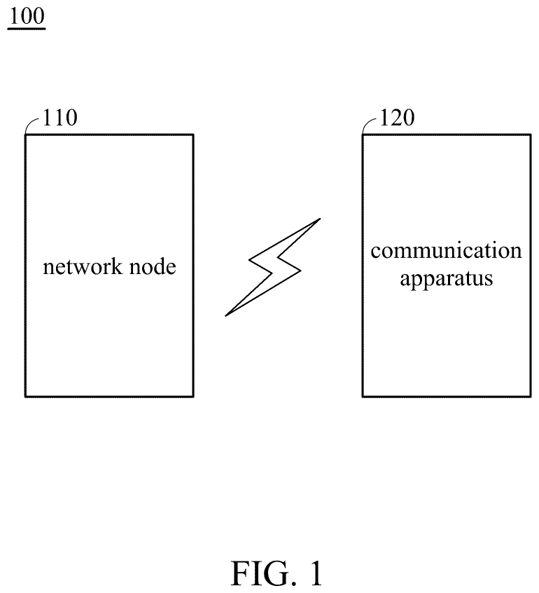

FIG. 1 is a block diagram of a wireless communication system 100 according to an embodiment of the application. As shown in FIG. 1, the wireless communication system 100 may include a network node 110 and a communication apparatus 120. It should be noted that, in order to clarify the concept of the invention, FIG. 1 presents a simplified block diagram in which only the elements relevant to the invention are shown. However, the invention should not be limited to what is shown in FIG. 1.

In an embodiment of the invention, the network node 110 may be a base station, a gNodeB (gNB), a NodeB (NB) an eNodeB (eNB), an access point (AP), an access terminal, a Wi-Fi hotpot, but the invention should not be limited thereto. In an embodiment, the communication apparatus 120 may communicate with the network node 110 through the fourth generation (4G) communication technology, fifth generation (5G) communication technology (or 5G New Radio (NR) communication technology), or sixth generation (6G) communication technology, but the invention should not be limited thereto. In another embodiment, the communication apparatus 120 may be in wireless communication with a wireless network including a non-terrestrial network (NTN) and a TN via the network node 110. That is, the network node 110 may be a terrestrial network node (e.g., an eNB, a gNB, or a transmission/reception point (TRP)) and/or a non-terrestrial network node (e.g., a satellite). For example, the terrestrial network node and/or the non-terrestrial network node may form an NTN serving cell for wireless communication with the communication apparatus 120. In another embodiment, the network node 110 may be an entity compatible with the Institute of Electrical and Electronics Engineers (IEEE) 802.11 standards to provide and manage the access to the wireless medium for the communication apparatus 120.

In the embodiments of the invention, the communication apparatus 120 may be a user equipment (UE), a non-AP station (STA), a smartphone, Personal Data Assistant (PDA), pager, laptop computer, desktop computer, wireless handset, or any computing device that includes a wireless communications interface. In addition, the communication apparatus 120 may be an entity compatible with the Institute of Electrical and Electronics Engineers (IEEE) 802.11 standards.

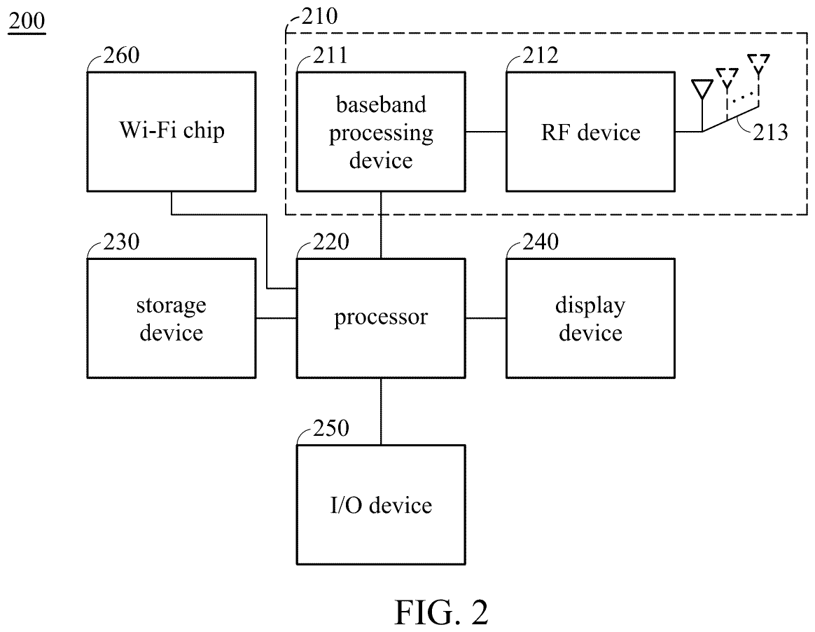

FIG. 2 is a block diagram illustrating a communication apparatus 200 according to an embodiment of the application. The communication apparatus 200 can be applied to the communication apparatus 120. As shown in FIG. 2, the communication apparatus 200 may comprise a wireless transceiver 210, a processor 220, a storage device 230, a display device 240, an Input/Output (I/O) device 250, and a Wi-Fi chip 260.

The wireless transceiver 210 may be configured to perform wireless transmission and reception to and from the communication apparatus 120.

Specifically, the wireless transceiver 210 may include a baseband processing device 211, a Radio Frequency (RF) device 212, and antenna 213, wherein the antenna 213 may include an antenna array for UL/DL MIMO.

The baseband processing device 211 may be configured to perform baseband signal processing, such as Analog-to-Digital Conversion (ADC)/Digital-to-Analog Conversion (DAC), gain adjusting, modulation/demodulation, encoding/decoding, and so on. The baseband processing device 211 may contain multiple hardware components, such as a baseband processor, to perform the baseband signal processing.

The RF device 212 may receive RF wireless signals via the antenna 213, convert the received RF wireless signals to baseband signals, which are processed by the baseband processing device 211, or receive baseband signals from the baseband processing device 211 and convert the received baseband signals to RF wireless signals, which are later transmitted via the antenna 213. The RF device 212 may comprise a plurality of hardware elements to perform radio frequency conversion. For example, the RF device 212 may comprise a power amplifier, a mixer, analog-to-digital converter (ADC)/digital-to-analog Converter (DAC), etc.

According to an embodiment of the invention, the RF device 212 and the baseband processing device 211 may collectively be regarded as a radio module capable of communicating with a wireless network to provide wireless communications services in compliance with a predetermined Radio Access Technology (RAT). Note that, in some embodiments of the invention, the communication apparatus 200 may be extended further to comprise more than one antenna and/or more than one radio module, and the invention should not be limited to what is shown in FIG. 2

The processor 220 may be a general-purpose processor, a Central Processing Unit (CPU), a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 210 for wireless communications with the network node 110, storing and retrieving data (e.g., program code) to and from the storage device 230, sending a series of frame data (e.g. representing text messages, graphics, images, etc.) to the display device 240, and receiving user inputs or outputting signals via the I/O device 250.

In particular, the processor 220 coordinates the aforementioned operations of the wireless transceiver 210, the storage device 230, the display device 240, the I/O device 250, and the Wi-Fi chip 260 for performing the method of the present application.

As will be appreciated by persons skilled in the art, the circuits of the processor 220 may include transistors that are configured in such a way as to control the operation of the circuits in accordance with the functions and operations described herein. As will be further appreciated, the specific structure or interconnections of the transistors may be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 230 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, communication protocols, and/or the method of the present application.

The display device 240 may be a Liquid-Crystal Display (LCD), a Light-Emitting Diode (LED) display, an Organic LED (OLED) display, or an Electronic Paper Display (EPD), etc., for providing a display function. Alternatively, the display device 240 may further include one or more touch sensors for sensing touches, contacts, or approximations of objects, such as fingers or styluses.

The I/O device 250 may include one or more buttons, a keyboard, a mouse, touch pad, a video camera, a microphone, and/or a speaker, etc., to serve as the Man-Machine Interface (MMI) for interaction with users.

According to an embodiment of the invention, the Wi-Fi chip 260 may comprise Wi-Fi antenna and may be configured to perform the operations of Wi-Fi communications.

According to an embodiment of the invention, the wireless transceiver 210 may be configured in a modem (MD) of the communication apparatus 200, and the processor 220 may be configured in an application processor (AP) or a host device of the communication apparatus 200. The modem may be coupled to the host device through a host interface. According to an embodiment of the invention, the host interface may comprise a peripheral component interconnect express (PCIe) interface, a secure digital input/output (SDIO) interface, a universal serial bus (USB) interface, or a universal asynchronous receiver/transmitter (UART) interface, but the invention should not be limited thereto.

It should be understood that the components described in the embodiment of FIG. 2 are for illustrative purposes only and are not intended to limit the scope of the application. For example, a communication apparatus may include more components, such as another wireless transceiver for providing telecommunication services, a Global Positioning System (GPS) device for use of some location-based services or applications, and/or a battery for powering the other components of the communication apparatus, etc. Alternatively, a communication apparatus may include fewer components. For example, the communication apparatus 200 may not include the display device 240 and/or the I/O device 250.

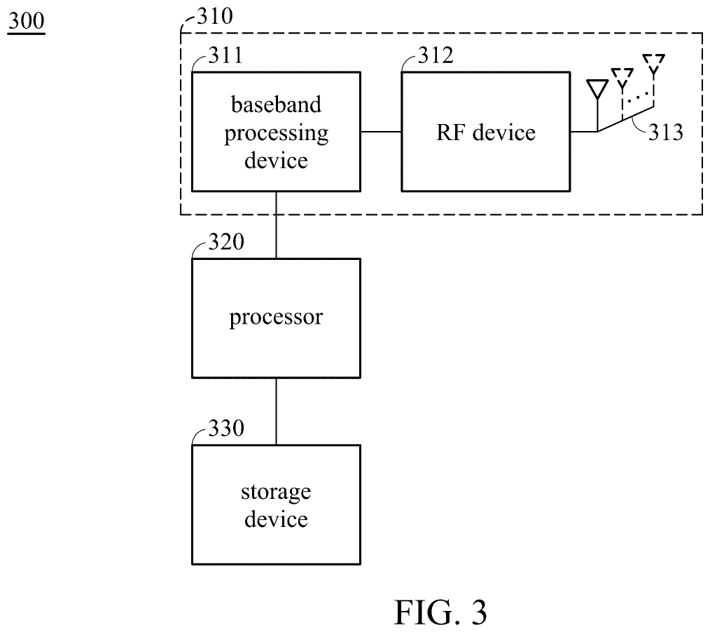

FIG. 3 is a block diagram illustrating a network node 300 according to an embodiment of the application. The network node 300 can be applied to the network node 110. As shown in FIG. 3, the network node 300 may comprise a wireless transceiver 310, a processor 320, and a storage device 330.

The wireless transceiver 310 is configured to perform wireless transmission and reception to and from one or more communication apparatuses (e.g., the communication apparatus 120).

Specifically, the wireless transceiver 310 may include a baseband processing device 311, an RF device 312, and antenna 313, wherein the antenna 313 may include an antenna array for UL/DL MU-MIMO.

The baseband processing device 311 is configured to perform baseband signal processing, such as ADC/DAC, gain adjusting, modulation/demodulation, encoding/decoding, and so on. The baseband processing device 311 may contain multiple hardware components, such as a baseband processor, to perform the baseband signal processing.

The RF device 312 may receive RF wireless signals via the antenna 313, convert the received RF wireless signals to baseband signals, which are processed by the baseband processing device 311, or receive baseband signals from the baseband processing device 311 and convert the received baseband signals to RF wireless signals, which are later transmitted via the antenna 313. The RF device 312 may comprise a plurality of hardware elements to perform radio frequency conversion. For example, the RF device 312 may comprise a power amplifier, a mixer, analog-to-digital converter (ADC)/digital-to-analog converter (DAC), etc.

The processor 320 may be a general-purpose processor, an MCU, an application processor, a DSP, a GPU/HPU/NPU, or the like, which includes various circuits for providing the functions of data processing and computing, controlling the wireless transceiver 310 for wireless communications with the communication apparatus 120, and storing and retrieving data (e.g., program code) to and from the storage device 330.

In particular, the processor 320 coordinates the aforementioned operations of the wireless transceiver 310 and the storage device 330 for performing the method of the present application.

In another embodiment, the processor 320 may be incorporated into the baseband processing device 311, to serve as a baseband processor.

As will be appreciated by persons skilled in the art, the circuits of the processor 320 may include transistors that are configured in such a way as to control the operation of the circuits in accordance with the functions and operations described herein. As will be further appreciated, the specific structure or interconnections of the transistors may be determined by a compiler, such as an RTL compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 330 may be a non-transitory machine-readable storage medium, including a memory, such as a FLASH memory or a NVRAM, or a magnetic storage device, such as a hard disk or a magnetic tape, or an optical disc, or any combination thereof for storing data, instructions, and/or program code of applications, communication protocols, and/or the method of the present application.

It should be understood that the components described in the embodiment of FIG. 3 are for illustrative purposes only and are not intended to limit the scope of the application. For example, a network node may include more components, such as a display device for providing a display function, and/or an I/O device for providing an MMI for interaction with users.

According to an embodiment of the invention, an apparatus (e.g., communication apparatus 120) may detect channel utilization (CU) information and physical (PHY) code information. Then, the apparatus may perform a rate adaptation according to the CU information and the PHY code information through a neural network (NN) model (or an artificial intelligence (AI) model or a machine learning (ML) model). That is, the apparatus may determine whether to change the rate (or data rate) according to the results of the rate adaptation.

Specifically, during the rate adaptation, the apparatus may perform a packet error rate (PER) prediction according to the CU information and the PHY code information through the neural network model to generate a prediction result. Then, the apparatus may select an appropriate target rate (e.g., a modulation and coding scheme (MCS) rate) from a rate table according to a prediction result. Then, the apparatus may perform data transmission with the network node according to the target rate.

According an embodiment of the invention, the rate table may comprise a plurality of data rate values corresponding to different MCSs. Therefore, according to the embodiments of the invention, the apparatus can directly find the appropriate target rate without needing to hierarchically try different MCSs to find the appropriate target rate. Therefore, the latency for the rate adaptation can be reduced.

According to an embodiment of the invention, the CU information may comprise at least one of a received signal strength indicator (RSSI), a signal-to-noise ratio (SNR), a noise variance (NE_VAR), and a link quality (LQ).

According to an embodiment of the invention, the PHY code may comprise at least one of a target MCS index, a target number of space-time streams (NSTS), a target medium access control (MAC) protocol data unit (MPDU) count (MPDU_CNT), a target transmission (TX) power (TX_PWR), a target power density (PWR_Density), a condition number (CN) corresponding to a target TX bandwidth (BW), and a target modulation type (MOD_TYPE).

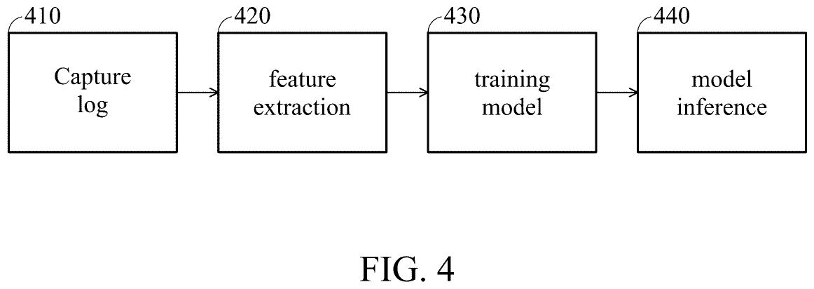

According to an embodiment of the invention, the neural network model comprises a fully connected neural network, but the invention should not be limited thereto. The neural network model may be pre-trained and stored in the apparatus. FIG. 4 is a schematic diagram illustrating a neural network model training process according to an embodiment of the invention. As shown in FIG. 4, in the neural network model transiting process, in step 410, the log files (e.g., binary files) of the packets from the apparatus are captured. In step 1, the fixed variable may comprise the environment (e.g., office) and the value of RSSI (e.g., −60 dBm), and the control variables may comprise the aggregation limit (AGG limit), bandwidth (BW), number of spatial streams (NSS), and MCS rate. In step 420, the feature of the log files may be extracted to form the file format of the input data of the neural network model. In step 430, the extracted data with the file format of the input data of the neural network model is input into the neural network model to train the neural network model. In step 440, the apparatus will be able to perform the data prediction (or model inference) through the trained neural network model.

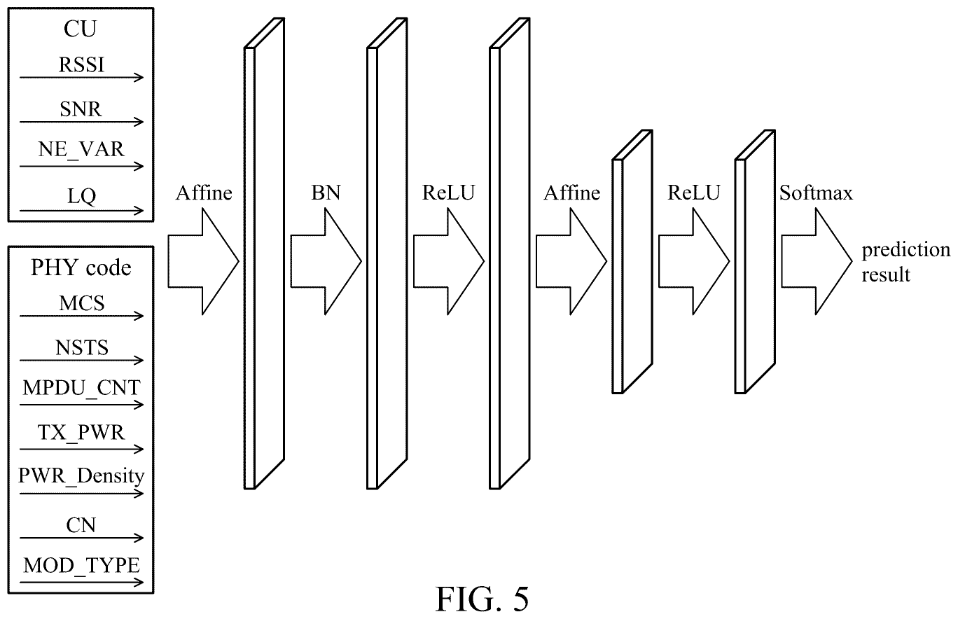

FIG. 5 is a schematic diagram illustrating a neural network model according to an embodiment of the invention. As shown in FIG. 5, the apparatus may input the CU information and the PHY code information into the neural network model. The neural network model may perform the neural network operations for the CU information and the PHY code information through different layers (e.g., Affine layer, batch normalization (BN) layer, rectified linear unit (ReLU) layer, and softmax layer) of the neural network model to generate the prediction result. Then, the apparatus will select an appropriate target rate (e.g., an MCS rate) from the rate table according to the prediction result. The Affine layer may calculate the input data to perform the linear transform for the input data. The BN layer may perform the normalization to the data to transform the data to the normal distribution with average=0. The ReLU layer may change the data with negative value to 0, and introduce non-linear transform for the data. The softmax layer may transform the data to probability distribution to generate the prediction result.

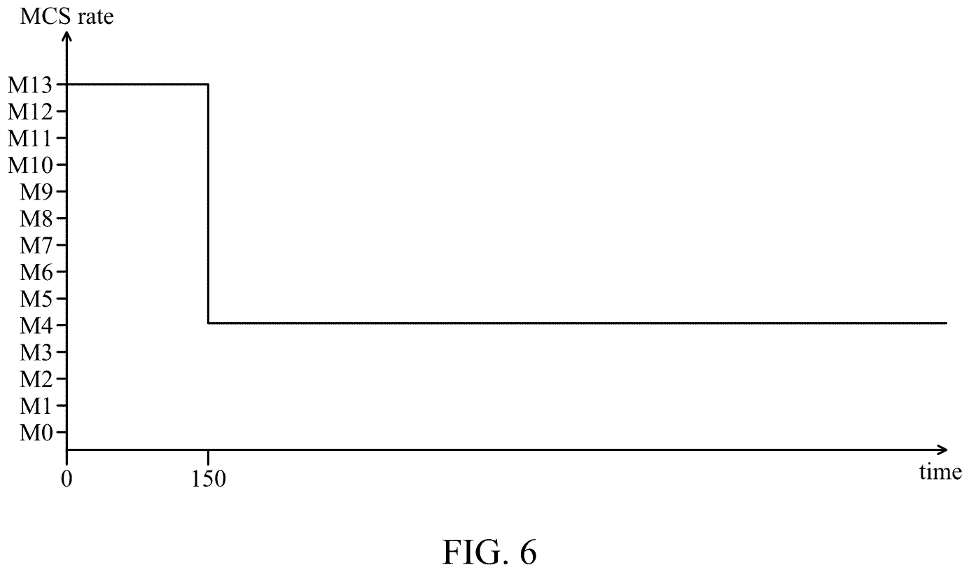

FIG. 6 is a schematic diagram illustrating a MCS rate adaptation according to an embodiment of the invention. As shown in FIG. 6, when the apparatus needs to adjust the rate, the apparatus may directly change the MCS rate from the MCS rate associated with the MCS index M13 to the MCS rate associated with the MCS index M4.

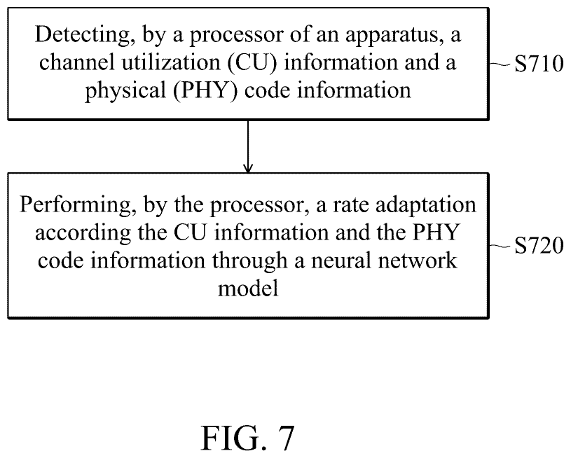

FIG. 7 is a flow chart illustrating a rate adaptation method 700 according to an embodiment of the invention. The rate adaptation method can be applied to the wireless communication system 100. As shown in FIG. 6, in step S710, the communication apparatus 120 may detect a channel utilization (CU) information and a physical (PHY) code information.

In step S720, the communication apparatus 120 may perform a rate adaptation according to the CU information and the PHY code information through a neural network model.

According to an embodiment of the invention, in the rate adaptation method, the CU information may comprise at least one of a received signal strength indicator (RSSI), a signal-to-noise ratio (SNR), a noise variance, and a link quality.

According to an embodiment of the invention, in the rate adaptation method, the PHY code may comprise at least one of a target modulation and coding scheme (MCS) index, a target number of space-time streams, a target medium access control (MAC) protocol data unit (MPDU) count, a target transmission (TX) power, a target power density, a condition number corresponding to a target TX bandwidth (BW), and a target modulation type.

According to an embodiment of the invention, in the rate adaptation method, the neural network model may comprise a fully connected neural network.

According to an embodiment of the invention, in the rate adaptation method, during the rate adaptation, the communication apparatus 120 may perform a packet error rate (PER) prediction according to the CU information and the PHY code information through the neural network model to generate a prediction result, and select a target rate from a rate table according to a prediction result.

According to the rate adaptation method provided in the embodiments of the invention, the apparatus can directly find the appropriate target rate according to the pre-trained neural network model without needing to hierarchically try different MCSs to find the appropriate target rate. Therefore, according to the rate adaptation method provided in the embodiments of the invention, the latency for the rate adaptation can be reduced.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A rate adaptation method, comprising:
detecting, by a processor of an apparatus, a channel utilization (CU) information and a physical (PHY) code information; and
performing, by the processor, a rate adaptation according to the CU information and the PHY code information through a neural network model.

2. The rate adaptation method of claim 1, wherein the CU information comprises at least one of a received signal strength indicator (RSSI), a signal-to-noise ratio (SNR), a noise variance, and a link quality.

3. The rate adaptation method of claim 1, wherein the PHY code comprises at least one of a target modulation and coding scheme (MCS) index, a target number of space-time streams, a target medium access control (MAC) protocol data unit (MPDU) count, a target transmission (TX) power, a target power density, a condition number corresponding to a target TX bandwidth (BW), and a target modulation type.

4. The rate adaptation method of claim 1, wherein the neural network model comprises a fully connected neural network.

5. The rate adaptation method of claim 1, wherein the performing of the rate adaptation further comprises:
performing, by the processor, a packet error rate (PER) prediction according to the CU information and the PHY code information through the neural network model to generate a prediction result; and
selecting, by the processor, a target rate from a rate table according to a prediction result.

6. An apparatus, comprising:
a transceiver which, during operation, wirelessly communicates with a network node; and
a processor communicatively coupled to the transceiver such that, during operation, the processor performs operations comprising:
detecting a channel utilization (CU) information and a physical (PHY) code information; and
performing a rate adaptation according to the CU information and the PHY code information through a neural network model.

7. The apparatus of claim 6, wherein the CU information comprises at least one of a received signal strength indicator (RSSI), a signal-to-noise ratio (SNR), a noise variance, and a link quality.

8. The apparatus of claim 6, wherein the PHY code comprises at least one of a target modulation and coding scheme (MCS) index, a target number of space-time streams, a target medium access control (MAC) protocol data unit (MPDU) count, a target transmission (TX) power, a target power density, a condition number corresponding to a target TX bandwidth (BW), and a target modulation type.

9. The apparatus of claim 6, wherein the neural network model comprises a fully connected neural network.

10. The apparatus of claim 6, wherein during the rate adaptation, the processor performs a packet error rate (PER) prediction according to the CU information and the PHY code information through the neural network model to generate a prediction result, and selects a target rate from a rate table according to a prediction result.
